(19) United States
(12) Patent Application Publication
(10) Pub. No.: US 2018/0313096 A1
(43) Pub. Date: Nov. 1, 2018

(54) RAISED FLOOR ARRANGEMENT AND PEDESTAL MEMBER FOR SUPPORTING TILES OF A RAISED FLOOR ARRANGEMENT

(71) Applicant: PHILIPS LIGHTING HOLDING B.V., EINDHOVEN (NL)

(72) Inventor: BERND VOELPEL, WÜRSELEN (NL)

(73) Assignee: PHILIPS LIGHTING HOLDING B.V., EINDHOVEN (NL)

(21) Appl. No.: 15/766,421

(22) PCT Filed: Sep. 23, 2016
(86) PCT No.: PCT/EP2016/072657

§ 371 Date: Apr. 6, 2018

(30) Foreign Application Priority Data
Oct. 6, 2015 (EP) 15188450.9

(51) Int. Cl. E04F 15/024; F21V 33/00; F21S 8/02

(52) U.S. Cl. CPC E04F 15/02405; F21V 33/006; F21V 23/0442; F21S 8/022; E04F 2290/026; E04F 15/02464

(57) ABSTRACT

The invention provides a raised access flooring arrangement comprising floor tiles mounted at different heights to create recessed spaces within which lighting elements may be mounted. The floor tiles are supported by a plurality of pedestal elements, each adapted for supporting tiles at the different heights.

### FIELD OF THE INVENTION

The invention relates to a raised access floor arrangement, in particular to a raised access floor arrangement having integrated lighting devices. The invention further relates to a pedestal member for supporting tiles of a raised floor arrangement.

### BACKGROUND OF THE INVENTION

Raised access floors are common and popular in the building industry. They comprise floor tiles supported at a raised level above the ground, for example by means of a series of pedestals. They create a hidden space between the floor tiles and the solid floor structure of a building within which electrical or mechanical infrastructure may be located for easy future access.

Solid state lighting technology supports new form factors which enable integration of lighting devices within raised access floors. Such integration may be desired for a wide range of particular applications, including for example, emergency path marking, directional instruction, aesthetic display or information display.

When integrating lighting devices within flooring arrangements, it is commonly desirable to achieve precise positioning of the devices relative to one or more other objects or installations within the room. However, in order to maintain a flush upper floor surface without protrusions or bumps, it is necessary that lighting devices be recessed into the plane of the floor (and hence into the tiles). It is necessary therefore that flooring arrangements into which lighting devices are to be integrated are provided with dedicated recesses at locations which correspond exactly with the desired mounting positions of the various lighting elements.

There are two standard ways in which this may be achieved. Firstly, standard tiles may be used throughout the flooring arrangement, but recesses cut or holes routed on-site by installers at the locations at which lighting elements are desired. This though requires the dedicated tools to be available on site for cutting the recesses and also leads to longer installation times, greater noise, and increased dust production at the installation site.

Alternatively, a custom set of pre-recessed raised access tiles may be provided directly from the factory, either having recesses pre-cut in specific custom locations in accordance with a known lighting plan, or having recesses provided at standard positions, and these tiles then simply installed on-site at the locations at which lighting elements are required.

Both of these solutions however require a dedicated secondary set of recessed tiles to be provided from the factory, which adds cost in terms of parts and furthermore adds complexity with regards to installation. Where custom tiles are provided, careful planning and liaising with the factory is required, and installation may take significantly longer, since each tile must be carefully checked against the flooring plan before being installed. If tiles with standard position recesses are provided, this nonetheless adds cost, since two different kinds of tile must be manufactured and installed.

An alternative solution is simply to use, for the mounting of lighting devices, a second set of tiles which are thinner than standard tiles, hence providing at these tile locations an entire tile surface which is recessed with respect to surrounding tiles, upon which lighting devices can be installed.

This adds greater flexibility in positioning of lighting devices (compared to tiles provided with a single small recess cut into one location on their surface), and potentially reduces complexity in installation therefore. However, it still requires the provision, positioning and careful fitting of two distinct kinds of tile which adds cost, delay and complexity to the installation process.

One alternative to the use of dedicated tiles is to use a single common type of tile throughout, and to simply mount certain tiles at a lower raised level compared with others, to provide a recessed space at that location for the mounting of lighting elements. Mounting raised access floor tiles at different heights in this way is not unknown, but is not favoured as an approach since it adds its own cost and complexity to the installation process.

In particular, the lower level tiles require dedicated low-level pedestal members to support them, and likewise, upper level tiles require a set of upper-level pedestal members. Furthermore, since they are mounted at different heights by means of different supporting members, neighbouring tiles cannot share use of any common pedestal elements (mounted their corners for instance), again adding cost—since not only do two different kinds of pedestal element need to be supplied, but neighbouring tiles of different heights each require a full set of four (or more) pedestal members to support them.

Required therefore is a raised access floor arrangement or system which allows flexible integration of lighting elements at specific desired locations, but which offers reduced installation complexity and cost compared to known solutions.

### SUMMARY OF THE INVENTION

The invention is defined by the claims.

According to an aspect of the invention, there is provided a raised floor arrangement comprising:

a plurality of floor tiles including a first set of floor tiles mounted at a first height and a second set of floor tiles mounted at a second height, different to the first height, each floor tile in said first set supporting:
a lighting unit disposed on its upper surface, and a planarization element having an upper surface coincident with a plane including the respective upper surfaces of the floor tiles in the second set; and

a plurality of pedestal elements mounted on a floor surface, each holding a first supporting member arrangement at said first height and a second supporting member arrangement at said second height, said floor tiles being mounted on said pedestal elements.

Each of the first and second supporting member arrangements may comprise a respective one or more supporting members, each supporting member comprising a respective supporting surface for supporting one or more floor tiles.

Embodiments of the invention hence provide a floor arrangement having tiles mounted at different heights—hence allowing recessed installation of lighting units within spaces formed by/upon the lower level tiles—but wherein both the upper and the lower level tiles are supported by a common set of pedestal elements, each having at least two dedicated supporting members (at least one comprised by each arrangement) arranged at different heights for supporting tiles at two different levels.

In some cases, each supporting member arrangement may comprise just one respective supporting member, adapted to support one or more tiles at the respective first or second height. In alternative examples, one or both of the supporting member arrangements may comprise a plurality (for example two or three) supporting members, each adapted to support one or more tiles at the first or second height.

In accordance with either of these two cases, the respective supporting surfaces of the first and second supporting member arrangements may be configured to be non-overlapping. In this way, each pedestal element may be used in supporting both an upper level tile and a lower level tile at the same time allowing for shared support of neighbouring upper and lower tiles within the arrangement.

This significantly reduces cost and complexity of installation of this arrangement compared to similar prior solutions in which differently levelled tiles are supported by means of dedicated sets of differently heighted pedestal members. A single, common set of pedestal members may be ordered from the factory, eliminating the need to carefully plan required numbers of each of two different sets of pedestal elements. In addition, since pedestal members may be shared by neighbouring upper and lower level tiles; fewer pedestal elements may be required in total, again reducing overall cost of the arrangement.

It should be understood that for the purposes of the present invention, ‘height’ may be interpreted as a meaning a dimension relative to the tiles themselves, as opposed for example to meaning a dimension relative to some fixed external reference frame (such as for instance the floor surface of the room in which the arrangement is assembled). In particular, ‘height’ may refer for example to a displacement along a direction parallel to the surface normals of one or both (where they coincide) of the two sets of floor tiles. According to this interpretation, the two heights of the two different sets of floor tiles refers simply to a measure of the relative perpendicular displacement of the two sets of tiles from one another. Where the upper surfaces of the first set define a first plane, and the upper surfaces of the second set defines a second plane, height in this case refers to a vertical displacement between these two planes.

The one or more pedestal elements may in examples be arranged at corners of one or more of the floor tiles. This allows the supporting member arrangements of the pedestal elements to be shared in supporting neighbouring tiles, i.e. one or more of the supporting member arrangements of said one or more pedestal elements may be adapted to support two or more floor tiles. In cases where a supporting member arrangement comprises just a single supporting member, said supporting member may be provided having a supporting surface of a size and shape sufficient for supporting two or more tiles at the same time. Alternatively, the supporting member arrangement may comprise a plurality of supporting members, each arranged and shaped for supporting a single tile, such that collectively the supporting member arrangement is adapted for supporting multiple tiles simultaneously at the same height.

According to one or more examples, one or both of the supporting member arrangements may be height adjustable relative the floor surface upon which the pedestal element is mounted. This provides greater flexibility with regards mounting heights of the first and second sets of tiles: the specific height at which one or both of the sets of tiles is mounted may be adjusted according to preferences or requirements. In some, cases, the first and second supporting member arrangements may be each be independently height adjustable with respect to the floor surface, such that the heights of both the first and second sets of floor tiles may be independently selected.

Alternatively, the first and second supporting member arrangements may be mechanically coupled to one another in such a way that they are height adjustable only as a combined pair. In this case, both are height adjustable relative to the floor surface, but their relative separation from one another is fixed. This provides reduced flexibility compared to independently adjustable arrangements, but allows for the pedestal element to be provided with a simpler height adjustment mechanism, which may reduce cost for example.

The planarization elements are arranged to provide a supporting cover over each of the lower level floor tiles at the same height as the upper level floor tiles, so as to ensure that the finished floor comprises a flat, consistent upper surface.

According to one or more examples, one or more of the planarization elements may be supported by a plurality of the floor tiles of the first set. Planarization elements may extend to cover multiple lower level tiles for instance. In some cases, planarization elements may extend over both lower and upper level tiles, forming a consistent level planarization layer which covers both kinds of tile. In particular examples, a single planarization element may be provided to cover all tiles in the arrangement, thus forming a consistent upper surface to the flooring arrangement.

In alternative examples however, each planarization element may be supported by a respective one of the first set of the floor tiles, i.e. a single planarization element is provided to cover each of the lower level floor tiles.

Each floor tile in the first set may further support a filler layer disposed between the floor tile and the planarization element. The filler level may provide structural support to the planarization layer for instance.

One or more of the planarization elements may comprise one or more light exit areas for allowing transmission of light generated by the lighting units. In examples, the planarization elements may be entirely light-transmissive, forming a covering window through which light may escape upwards.

The floor arrangement may further comprise a floor cover, the floor cover being at least partially light-transmissive, and arranged to be parallel with the plane including the respective upper surfaces of the floor tiles in the second set, for creating a lighting effect. The floor cover may for example comprise a carpet covering. The floor covering may comprise a single cohesive layer covering all of the tiles in the arrangement or may comprise a plurality of covering elements, such as individual carpet tiles for example.

The floor cover may comprise for example shaped window elements for creating the lighting effect. The window elements may be formed of a different—light transmissive—material to surrounding portions of the covering. Alternatively the window elements may simply comprise shaped holes or openings in the covering.

The window elements may in examples be shaped to form words, letters, arrows or other symbols.

The floor arrangement may further comprise one or more sensors for facilitating sensor-based control of one or more of the lighting units. The sensors may for instance be pressure sensors, which may operatively connect with an external control system for example, the control system configured for controlling activation, deactivation, intensity level, or other control parameters of the lighting elements at least partially in response to detected pressure. The pressure sensors may be used to detect the presence of persons standing or walking on the flooring arrangement for example, or in particular to detect the presence of persons standing or walking within the vicinity of a specific one or more of the lighting elements.

Other varieties of sensor may additionally or alternatively be provided in embodiments including for example light sensors adapted to detect or measure light levels above the flooring arrangement for use in adjusting the brightness or intensity of the lighting units for instance. Other sensors which may be provided include for example temperature sensors or optical presence-detecting sensors (e.g. PIR sensors).

Examples in accordance with another aspect of the invention provide a pedestal element for a raised floor arrangement in accordance with any of the embodiments described above, comprising:

a first supporting member arrangement, arranged at a first height;

and a second supporting member arrangement, arranged at a second height, different to the first height.

Each of the first and second supporting member arrangements may comprise a respective one or more supporting members, each supporting member comprising a respective supporting surface for supporting one or more floor tiles.

In particular, the respective supporting surfaces comprised by the first and second supporting member arrangements may be non-overlapping, thus allowing for each pedestal member to support both an upper level tile and a lower level tile at the same time.

### BRIEF DESCRIPTION OF THE DRAWINGS

Examples of the invention will now be described in detail with reference to the accompanying drawings, in which:

FIG. 1 shows a first example flooring arrangement in accordance with an embodiment;

FIG. 2 shows a first example pedestal element for use in embodiments of the invention;

FIG. 3 illustrates a second example pedestal element for use in embodiments of the invention;

FIG. 4 illustrates a third example pedestal element for use in embodiments of the invention; and

FIG. 5 shows a second example flooring arrangement.

### DETAILED DESCRIPTION OF THE EMBODIMENTS

The invention provides a raised access flooring arrangement comprising floor tiles mounted at different heights to create recessed spaces within which lighting elements may be mounted. The floor tiles are supported by a plurality of pedestal elements, each adapted for supporting tiles at the different heights.

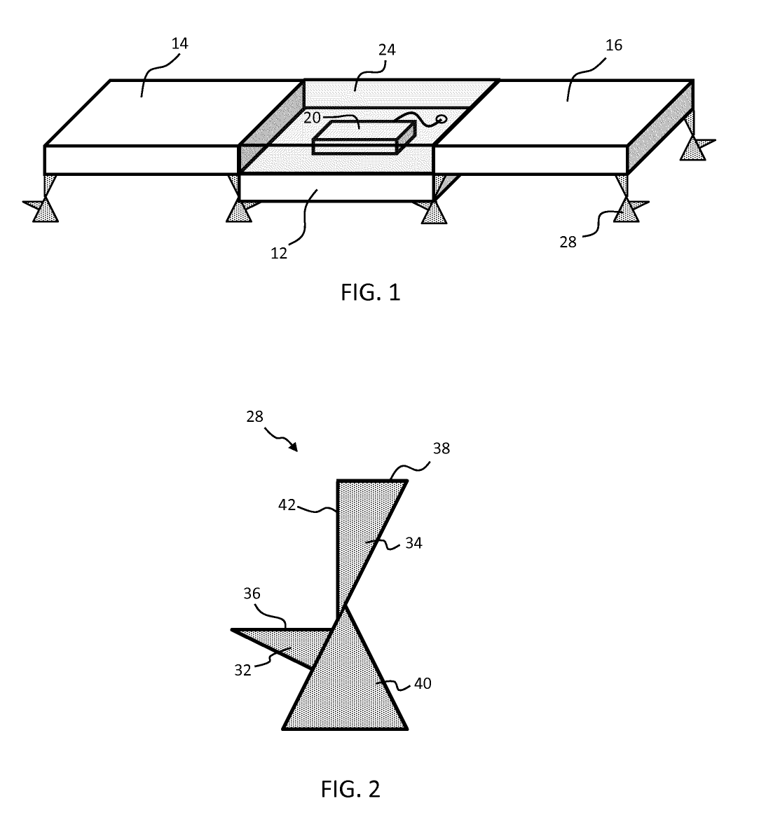

FIG. 1 schematically depicts a portion of an example raised access flooring arrangement in accordance with an embodiment of the invention. A first floor tile 12 is mounted at a first (lower) height and is neighboured on either side by a second 14 and third 16 floor tile, each mounted at a second (upper) height.

The second 14 and third 16 tiles define a cavity or space between the upper surface of the first tile 12 and the plane containing the upper surfaces of the second and third tile. Within this space, mounted atop the upper surface of the first tile, is a lighting device 20 having a light emitting surface facing in the direction of the surface normal of the upper surface of the first tile.

In the particular example shown in FIG. 1, the second (upper height) is such that the lower planar surface of the second 14 and third 16 floor tiles is substantially level with the upper planar surface of the first floor tile 12. As such, the defined cavity has a height substantially equal to the height of a single tile. In alternative examples, however, the second and third floor tiles may be arranged at respective heights such that the cavity defined by them has a height substantially equal to the height of the lighting device 20.

Also supported by the upper surface of the first tile 12 is a planarization element 24 having an upper surface arranged coincident with the plane containing the upper surfaces of the second 14 and third 16 tiles. The planarization element in this case comprises a light-transmissive window element for allowing transmission of light emitted by the lighting device 20. The upper surfaces of the second 14 and third 16 tiles, and the planarization element 24, together provide a single, level, weight-bearing upper surface for the flooring arrangement.

The planarization element may comprise a single, solid unit, having a thickness equal to the height of the cavity between the upper surface of the first tile 12 and the plane containing the upper surfaces of the second and third tile. In this case the light transmissive window element may comprise simply a hole or space in the planarization element. Alternatively the planarization element may be formed of a light transmissive material, such that the light transmissive window element comprises simply an upper surface of the planarization element.

Alternatively, the planarization element may be formed of several co-operating components, for example defining a supportive frame or scaffold, and having a window element disposed across the top. This might comprise, by way of one example, four rectangular pieces of (for instance) wood, which are screwed or otherwise affixed to the top surface of the first tile 12, and which support a planarizing upper window element.

Each of the tiles is supported at each of its corners by a pedestal element 28. The first tile 12 and second tile 14 share a common pair of pedestal elements, each simultaneously supporting a respective corner of each of the tiles. The first tile 12 and third tile 16 also share a common pair of pedestal elements, configured in a similar manner.

FIG. 2 schematically depicts an example pedestal element 28. Each pedestal element comprises a first and second supporting member arrangement, each formed of a single respective supporting member, the first arrangement formed by first supporting member 32, and the second arrangement formed by second supporting member 34. The first supporting member 32 has an upper surface 36 arranged to support a floor tile at the first (lower) height, and the second supporting member 34 has an upper surface 38 arranged to support a floor tile at the second (upper) height. Both the first 32 and second 34 supporting members are mounted or joined to a base member 40, which provides structural support to the supporting members, and whose lower surface makes contact with the supporting floor surface of the room in which the flooring arrangement is to be installed.

The second supporting member 34 is shaped having a planar surface 42 on one side, such that this surface and the upper surface 36 of the first supporting member 32 together define a right angled space into which a corner or side of a floor tile may be fitted or rested. Furthermore, the shape of the second supporting member is such that its own supporting surface 38 and that 36 of the first supporting member do not overlap with one another. In this way, each pedestal element 28 may simultaneously support floor tiles at both a lower and an upper height.

In addition, the shape of the pedestal element 28 is such that the supporting surfaces 36, 38 of the two supporting members 32, 34 are disposed directly adjacent to one another in a horizontal direction: that is, the left-most edge of the second supporting member begins directly where the right-most edge of the first supporting member ends (although with a vertical displacement). This confers the significant advantage that all floor tiles of the floor arrangement may be mounted directly flush with one another (in a horizontal direction); the floor tiles may be arranged to tessellate perfectly, without gaps or spaces between them where for example portions of supporting pedestal members protrude.

This is possible in the example of FIG. 2 in virtue of the fact that the upper-most surface of the pedestal member itself is used as the second supporting surface 38 to support the upper layer of tiles. This means that no part of the pedestal member ever protrudes beyond the level of the lower surfaces of the second 14 and third 16 tiles, and no parts of the pedestal elements are visible once the floor arrangement has been installed. This confers clear advantages in terms of aesthetics, since an arrangement may be provided in which the pedestal elements are completely hidden from view once the floor is installed.

In the particular example of FIG. 2, the base member 40 comprises an inverse conical-shaped member, having its major planar surface disposed downward, for supporting the pedestal element 28. However, it is to be understood that embodiments are not limited to such a shape, and in alternative examples, the base member may instead comprise for example a cubic, cuboidal, or pyramidal shaped structure, as well as for instance frustums of these shapes.

In addition, although in the particular example of FIG. 2, the first supporting member 32, second supporting member 34 and base member 40 are depicted as separate, distinct elements, being mounted or joined to one another, it is to be understood that this is purely illustrative, and in alternative examples, these components of the pedestal element may instead comprise sections or portions of a single integrated unit or structure.

The first supporting member 32 in the example of FIG. 2 comprises a half-cone shaped structure. However, in alternative examples, this member may instead be formed of a differently shaped structure, such as for instance a partial or complete cubic, cuboidal or cylindrical element.

By way of example, the pedestal elements may for instance be formed of galvanized steel or steel alloy, or (reinforced) plastic.

Referring again to the flooring arrangement of FIG. 1, in variant examples, there may further be provided, between the upper surface of the first tile 12 and the upper surface of the planarization element 24 a filler layer. The filler layer may completely or partially fill the cavity formed between the first tile 12 and the upper surface of the planarization element.

The filler layer may provide for instance structural support to the upper surface of the planarization element 24. In such an example, a planarization element may be provided comprising for instance just a single planarization layer element—for instance a light-transmissive tile or window—having a surface area which substantially matches that of the first tile 12, and disposed atop the upper surface of the filler layer.

In addition, the filler layer may act to hold the lighting device 20 fixed in position atop of the first tile 12, avoiding the need to provide a dedicated affixing means for mounting the device to the tile.

The filler layer may be at least partially light-transmissive to allow the transfer of light from the light emitting surface of the lighting element 20 to the light-transmissive upper surface of the planarization element 24. Alternatively, the filler layer may be opaque or substantially opaque, but be provided with one or more light-transmitting cavities or channels running between the light emitting surface of the lighting element and the upper surface of the planarization element 24. In this way, the filler layer itself may provide structural support to the planarization element, but without the material comprising it needing to be translucent or transparent.

In some examples, the filler layer may itself perform the role of the planarization element, providing a solid upper surface arranged level with the upper surfaces of the second 14 and third 16 tiles. This would therefore eliminate the necessity for a separate dedicated planarization element in addition to a filler layer.

According to one set of examples, the height difference between the upper surface of the first tile 12 and the upper surface of the second 14 and third 16 tiles exactly matches the height of the provided lighting element 20. The gaps surrounding the lighting elements (i.e. the surrounding cavity) may in this case be filled by a filler material (filler layer), up to the level of the upper surfaces of the second and third tiles. In this way, the light emitting upper surface of the lighting element is left exposed (not covered by the filler layer), and a planarization layer is provided by the top surface of the filler material exactly aligned with the upper surfaces of the surrounding tiles.

In some cases, a larger height difference than the thickness of the light source may be desired (for example to cope with production or assembly tolerances). In this case, there may be room between the upper surface of the lighting element 20 and the upper surfaces of the second 14 and third 16 tiles to provide optical components such one or more lenses or windows.

In examples, the filler layer may comprise wood, plastic or metal.

Where a separate planarization element is provided, this may comprise, by way of example, wood, plastic, polycarbonate, glass or metal.

The lighting element 20 according to one or more examples may comprise one or more solid state lighting elements such as LEDs. Alternatively, the lighting element may comprise a filament or fluorescent lighting element for instance. The lighting element may be adapted to emit light of a single particular colour, or to emit light of a range of different colours.

The full flooring arrangement comprises an extended version of the arrangement shown in FIG. 1, with all tiles mounted at the first (lower) height forming a first set of floor tiles and all tiles mounted at the second (upper) height forming a second set of floor tiles. In examples, the second set of floor tiles may comprise the majority of the tiles of the full flooring arrangement, with lower level tiles being installed only at certain limited locations for instance. In other examples, however, there may be substantially equal numbers of lower-level 12 and upper-level 14, 16 tiles.

Each pedestal element 28 within a full flooring arrangement may typically support the adjoining corners of four neighbouring tiles. Depending upon the intended pattern or configuration of lower versus upper tiles across the flooring arrangement, the particular shape, structure or composition of the first and/or second supporting member arrangements of the pedestal elements may be required to vary. For example, where it is known that within the full flooring arrangement, a lower tile is to be surrounded on all (four) sides by upper tiles, the pedestal elements at the corners of the lower tile will be required to support simultaneously one lower tile and three upper tiles. This may be achieved for example through providing pedestal elements in which the second supporting member arrangement comprises supporting surfaces arranged or shaped to provide support across three consecutive ‘quadrants’ of the corner formed at the meeting point of the tiles and the first supporting member arrangement comprises supporting surfaces arranged or shaped to provide support across the remaining quadrant of the corner.

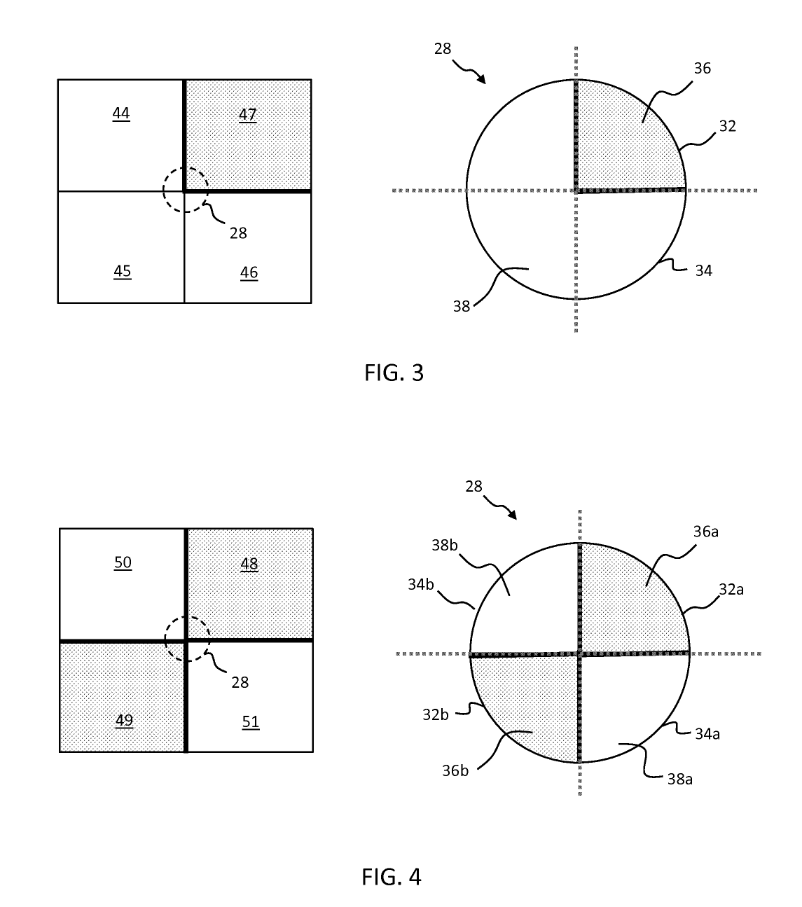

This is illustrated in FIG. 3 which schematically depicts a top-down view of an example pedestal element 28 adapted for supporting adjoining corners of three upper tiles 44, 45, 46 and a single lower tile 47. The pedestal element comprises a first supporting member 32 having an upper surface disposed level with a lower surface of lower tile 47, and having a quarter-circle shape which extends across a first quadrant, formed by the lower tile 47. The pedestal element further comprises a second supporting member 34, having an upper surface 38 disposed level with lower surfaces of upper tiles 44, 45 and 46, and having a three-quarter circle shape which extends across the remaining three adjacent quadrants, formed respectively by the first 44, second 45 and third 46 upper tiles.

The example depicted in FIG. 3 represents a case in which the first and second supporting member arrangements each comprise a single supporting member each. In alternative examples, pedestal elements 28 may be provided comprising a first and second supporting member arrangement, one or both of which is formed by two or more separate supporting members. This may be necessary for certain tile configurations—in particular where a single pedestal is required to support pairs of diagonally opposite tiles at a single given height, rather than adjacent tiles disposed at the same height.

An example of such a configuration is shown in FIG. 4, which depicts a top-down view of an example pedestal element adapted for supporting adjoining corners of alternatively arranged upper 50, 51 and lower 48, 49 tiles. The pedestal element comprises a first supporting arrangement—formed of a first supporting member 32a, having a first supporting surface 36a, and a second supporting member 32b, arranged diagonally opposite to the first supporting member, and having a second supporting surface 36b—and a second supporting member arrangement—formed of a third supporting member 34a, having a third supporting surface 38a, and a fourth supporting member 34b, arranged diagonally opposite to the third, and having a fourth supporting surface 38b. The first 36a and second 36b supporting surfaces are arranged level with lower surfaces of the two lower tiles 48 and 49, and the third 38a and fourth 38b supporting surfaces are arranged level with the lower surfaces of the two upper tiles 51 and 50.

In examples, the supporting member(s) of the first and/or second supporting member arrangements may be rotatable about a central vertical axis of the pedestal element, in order thereby to enable adjustment of the angular orientations of the supporting members. This provides flexibility with regards to the particular patterns or configurations of upper and lower tiles which the pedestal member is able to support.

Furthermore, in accordance with one or more embodiments, one or more of the supporting member arrangements may be height adjustable. In certain cases, the two supporting member arrangements may be each independently height adjustable relative to the floor surface upon which the pedestal element 28 is mounted. In this case, the height of each of the first and second sets of floor tiles may be adjusted independently of one another. In other examples however, the first and second supporting member arrangements may be mechanically coupled in such a way that the two are height adjustable only as a combined pair, and have a fixed relative (vertical) separation from one another. This allows for the pedestal element to be provided with a simpler height adjustment mechanism, since only one independent rotational action is required to be facilitated, rather than two. This may in turn reduce production costs of the pedestal elements.

Height adjustment may, in examples, be facilitated by means of a screw and thread mechanism, in which the pedestal element is divided into two or more vertical sections being threadedly coupled to one another. The threaded coupling allows the relative vertical separation of the respective sections to be adjusted.

For example, the pedestal element illustrated in FIG. 2 might be adapted in embodiments to comprise a height adjustable second supporting member 34 through providing a threaded coupling between the second supporting member and the base member 40. The second supporting member may, for example, be provided a threaded rod or core which protrudes vertically downwards from one of its surfaces. The base member may correspondingly be provided with a co-operating threaded socket for receiving the threaded core or rod, which extends vertically downwards into the body of the supporting member. In this way the vertical separation of the base member 40 and the second supporting member 34 may be varied, through varying how far the rod or core of second supporting member is threaded into the receiving socket.

Although an example has been described in which the base member 40 comprises a receiving threaded socket, and the second supporting member 34 comprises an engaging threaded rod, it will naturally be understood that the opposite configuration (in which the base member comprises a rod, and the supporting member comprises a socket) is equally feasible and confers identical advantages.

In examples, the pedestal element may further be provided with a retaining or locking means for releasably securing the upper supporting member at a particular given rotational position. Alternatively, a non-releasable securing means might instead be used to keep the supporting members rotationally fixed in place, such as glue or adhesive applied to the threads once adjustment has been made.

As described above, according to further examples, both the first 32 and second 34 supporting members may be adapted to be independently height adjustable, or jointly height adjustable as a coupled pair.

In the first instance, the pedestal member 28 may simply be divided into three vertical parts or sections, the first comprising just the second supporting member 34, the second comprising the first supporting member 32 and an upper portion of the base member 40 to which the supporting member is attached, and the third comprising the remaining lower portion of the base member 40. Each section is provided with appropriate respective rods and sockets so as to allow the first section to be adjustable relative to the second, and the second relative to the first.

In the second instance, the pedestal element 28 may instead be divided into two vertical sections, but wherein the first section comprises both the first and second supporting members, and is threadedly coupled to a lower portion of the base member 40 (section 3, for instance, as described in the preceding example).

It is noted that where height adjustability is provided by means of a screw mechanism, as described in examples above, consideration must be made of the fact that only a constrained set of discrete height levels will in practice be achievable in virtue of requirements on the rotational orientation of the various supporting members. Since supporting members are not rotationally symmetric, they require to be positioned at particular rotational positions. This means that, in many examples, they may only be adjustable to those heights which are separated by multiples of 360-degree rotations.

This limitation might be avoided through provision of a separate mechanism to facilitate free rotation of one or both of the supporting member arrangements independently of the height adjustment mechanism. This may increase cost of each pedestal unit, but would provide maximal flexibility in terms of height adjustment of the supporting members.

According to one or more examples, the finished upper surface of the flooring arrangement—formed jointly by the upper surfaces of the second set of floor tiles 14, 16 and the upper surfaces of the planarization elements 24—may be further covered by a final finishing layer, for example a carpet or other floor cover. In particular, the finishing layer or floor cover may in examples be at least partially light transmissive, or comprise light transmissive elements or sections.

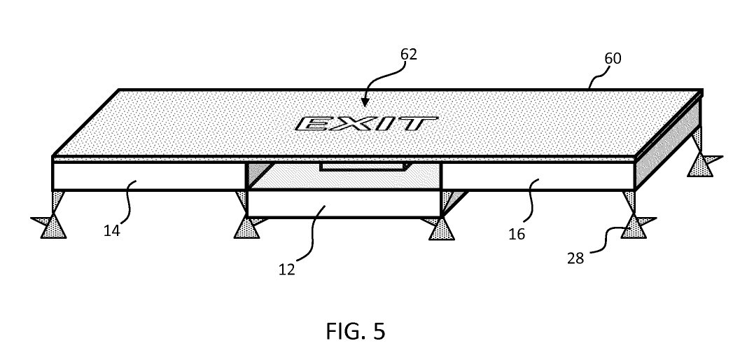

FIG. 5 shows one example of a portion of a floor arrangement in accordance with an embodiment, comprising a floor cover layer 60 disposed over the top of the upper surfaces of the second 14 and third 16 floor tiles and of the planarization elements 24. The floor cover comprises a set of light-transmissive window elements 62, shaped to form the word ‘EXIT’. These act as a light transmissive mask. Light emitted by the lighting element 20 disposed in the cavity beneath propagates through to the window elements 62, illuminating the letter shapes which they form and thereby providing an illuminated ‘EXIT’ sign built into the flooring arrangement.

It is noted that in the schematic illustration of FIG. 5, the ‘EXIT’ window configuration is shown extending beyond the dimensions of the lighting unit 20 provided to illuminate it. In practical applications, illumination of the full EXIT display according to this arrangement would thus require one or more optical elements, in order to extend the illumination across the whole window area. Alternatively, the lighting unit may instead be provided having a light emitting area which extends to match the particular shaped window arrangement.

The window elements 62, in examples, may be formed of a light-transmissive material, different from the material forming the bulk of the floor covering 60. In alternative examples, however, the window elements may simply comprise shaped holes or openings in the floor cover 60.

This arrangement of FIG. 5 represents just one illustrative example, and in alternative examples, a floor covering may be provided comprising window elements 62 which form different words, symbols or shapes, in order to convey different messages or information to users walking over the flooring arrangement.

According to some examples, window elements may be provided, not forming letters or symbols for communicating information, but forming shapes or arrangements intended for creating purely aesthetic effects.

In certain examples, the floor cover 60 itself may be at least partially light transmissive across its entire extent. In this case, dedicated window elements may not be provided, since light may be transmitted directly through the material of the covering. This may be preferred, for instance, where it is desirable that the presence of the lighting elements 20 not be noticeable when the lights are switched off.

According to one set of examples, the lighting elements 20 themselves may be adapted to generate one or more light patterns or shapes for producing a lighting effect. In some cases, they may be adapted for generating variable lighting patterns or configurations. For example, the light sources 20 may comprise one or more LED matrix displays, configurable to display illuminated content which is dynamically changeable. In this case, the floor cover may be adapted to be light transmissive across the entire area covering the light source, such that the generated light displays are visible through the top of the flooring arrangement.

For instance, such a display may be adapted to provide moving or flashing messages or indications, or to provide static messages whose content is changeable depending on certain contextual factors.

Although a dynamically adjustable light source represents one example, in other cases, light sources 20 may be provided which are adapted to produce a fixed, non-variable light output or pattern, to display a message or indicator whose content does not change.

In either of the above cases, a floor cover may be provided having transmissive or semi-transmissive portions adapted such that when the light sources are switched off, the light effect of the light sources is hidden from view. This hence allows—even in the case of devices providing non-variable light outputs—that content may be selectively displayed or hidden.

According to one or more embodiments, the lighting arrangement may further comprise one or more pressure sensor elements for detecting pressure applied across one or more surfaces of the arrangement. The pressure sensors may for example be mounted to some or all of the upper surfaces of the second (higher) set of floor tiles, and adapted to detect pressure applied to the upper surfaces of these tiles. The pressure sensors may for example be operatively connected to a controller unit or control circuit and their outputs used in controlling one or more of the lighting elements across the flooring arrangement.

For example, the pressure sensors may be used to detect the presence or motion of persons in the vicinity of a particular one or more of the lighting elements, and this output used to trigger the activation of the lighting elements, or the adjustment or control of one or more lighting parameters, such as for instance brightness or colour.

Incorporation of other varieties of sensor might also be considered in further examples, such as by way of non-limiting example, light-level sensors, heat sensors, smoke detectors or acoustic sensors.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1. A raised floor arrangement comprising:
a plurality of floor tiles including a first set of floor tiles mounted at a first height and a second set of floor tiles mounted at a second height, different to the first height, each floor tile in said first set supporting:
a lighting unit disposed on its upper surface, and
a planarization element having an upper surface coincident with a plane including the respective upper surfaces of the floor tiles in the second set; and
a plurality of pedestal elements mounted on a floor surface, each holding a first supporting member arrangement at said first height and a second supporting member arrangement at said second height, said floor tiles being mounted on said pedestal elements.

2. A raised floor arrangement as claimed in claim 1, wherein each of the first and second supporting member arrangements comprises a respective one or more supporting members, each supporting member comprising a respective supporting surface for supporting one or more floor tiles.

3. A raised floor arrangement as claimed in claim 2, wherein at least one of the first and second supporting member arrangements comprises a plurality of supporting members.

4. A raised floor arrangement as claimed in claim 1, wherein the respective supporting surfaces of the first and second supporting member arrangements are non-overlapping.

5. A raised floor arrangement as claimed in claim 2, wherein at least one of the supporting members of said one or more pedestal elements is adapted to support two or more floor tiles.

6. A raised floor arrangement as claimed in claim 1, wherein one or both of the supporting member arrangements is height adjustable relative to the floor surface

7. A raised floor arrangement as claimed in claim 1, wherein one or more of the planarization elements comprise one or more light exit areas for allowing transmission of light generated by the lighting units.

8. A raised floor arrangement as claimed in claim 1, wherein each floor tile in said first set further supports a filler layer disposed between the floor tile and the planarization element.

9. A raised floor arrangement as claimed in claim 1, further comprising a floor cover, being at least partially light-transmissive, and arranged parallel with the plane including the respective upper surfaces of the floor tiles in the second set, for creating a lighting effect.

10. A raised floor arrangement as claimed in claim 9, wherein said floor cover comprises shaped window elements for creating the lighting effect.

11. A raised floor arrangement as claimed in claim 1, further comprising one or more sensors for facilitating sensor-based control of one or more of the lighting units.

12. (canceled)

13. (canceled)

14. (canceled)

15. (canceled)
